(19) United States
(12) Patent Application Publication
(10) Pub. No.: US 2016/0344438 A1
(43) Pub. Date: Nov. 24, 2016

(54) PROTECTIVE CASE FOR TABLET COMPUTER

(71) Applicant: Electronic Silk Road (Shenzhen) Tech Co., Ltd., Shenzhen (CN)

(72) Inventor: Chuan-cheng Wu, Shenzhen (CN)

(21) Appl. No.: 14/855,417

(22) Filed: Sep. 16, 2015

(30) Foreign Application Priority Data
May 18, 2015 (CN) 201520321377.7

(51) Int. Cl. H04B 1/3888; H04M 1/02

(52) U.S. Cl. CPC H04B 1/3888; H04M 1/0279

(57) ABSTRACT

Disclosed is a protective case for tablet computer, which includes a base body for holding a tablet computer and a cover body covering on the base body. The cover body includes a bottom cover tightly attached to the base body and a top cover connected with the bottom cover. The top cover is divided into a first folding part, a second folding part, a third folding part and a fourth folding part by a first crease, a second crease and a third crease formed on a top surface of the top cover. When the top cover is opened and rotated to the back of the bottom cover, the bottom cover is supported by the first folding part or the fourth folding part and the first folding part or the fourth folding part contacts with an external supporting surface. The present invention can provide support for tablet computer in vertical direction.

### CROSS-REFERENCE TO RELATED APPLICATIONS

This present invention claims the benefit of Chinese Patent Application No. CN201520321377.7, filed on May 18, 2015; the contents of which are hereby incorporated by reference.

### FIELD OF THE INVENTION

The present invention relates to a protective case for tablet computer, and more particularly to a protective case for tablet computer which can provide support for tablet computer in vertical direction.

### BACKGROUND OF THE INVENTION

The protective case for tablet computer is used to support and protect the tablet computer. In order to provide support for the tablet computer, the existing protective case for tablet computer is provided with a supporting frame on the cover thereof. However, such a complex structure causes the whole protective case to be too thick. Moreover, the existing protective case for tablet computer can only provide a support in horizontal direction, but cannot provide a support in vertical direction, thus it cannot satisfy the needs of the consumers who used to use the tablet computer in vertical direction. On the market, there also has a protective case for tablet computer providing support via folding structures, but such a kind of protective case has so many folding pieces that its cost is too high.

### SUMMARY OF THE INVENTION

One object of the present invention is to provide a protective case for tablet computer so as to overcome the defects of the prior art.

To achieve above objects, there is provided a technical solution as follows:

A protective case for tablet computer includes a base body for holding a tablet computer, and further includes a cover body covering on the base body, the cover body including a bottom cover tightly attached to the base body and a top cover connected with the bottom cover and forming a detachable structure together with the top cover; the top cover is divided into a first folding part, a second folding part, a third folding part and a fourth folding part by a first crease, a second crease and a third crease formed on a top surface of the top cover; the first crease extends from a first point on a free edge of the top cover to a rotating edge of the top cover, the second crease extends from a second point on the free edge of the top cover to the rotating edge of the top cover, the first crease and the second crease are converged at a corner close to the rotating edge of the top cover, and the third crease extends from a second point on the free edge of the top cover to another corner close to the rotating edge of the top cover; and when the top cover is opened and rotated to the back of the bottom cover, the bottom cover is supported by the first folding part or the fourth folding part and the first folding part or the fourth folding part contacts with an external supporting surface.

According to the above solution, the top cover is divided into a first folding part, a second folding part, a third folding part and a fourth folding part by a first crease, a second crease and a third crease formed on a top surface of the top cover, and such a structure is simple and brings lower cost of production. The cover body is provided to protect the tablet computer when it is closed. When the top cover is opened and rotated to the back of the bottom cover, the bottom cover is supported by the first folding part or the fourth folding part and the first folding part or the fourth folding part contacts with an external supporting surface, thereby the tablet computer is supported by the cover body in vertical direction so as to satisfy the needs of the user.

In a preferable embodiment, the first folding part has a first corner with a range of 15-25 degree and opposite to the free edge.

In a preferable embodiment, the second folding part has a second corner with a range of 20-30 degree and opposite to the free edge.

In a preferable embodiment, the third folding part has a third corner with a range of 55-65 degree and opposite to the rotating edge.

In a preferable embodiment, the fourth folding part has a fourth corner with a range of 15-25 degree and opposite to the free edge.

In a preferable embodiment, the first corner is 20 degree; the second corner is 25 degree; the third corner is 60 degree; and the fourth corner is 20 degree.

According to the above solution, due to the design of the first corner being 20 degree, the second corner being 25 degree, the third corner being 60 degree and the fourth corner being 20 degree, the angle between the tablet computer and the external supporting surface is 60 degree when the tablet computer is supported by the protective case, thus it is easy to use.

In a preferable embodiment, both of the first folding part and the fourth folding part are provided with a first magnetic element at a position close to the free edge; and the bottom cover is provided with second magnetic elements corresponding to the first magnetic elements.

According to the above solution, when the the top cover is covered on the bottom cover, the first magnetic elements and the second magnetic elements attract each other so as to prevent the top cover from moving relative to the bottom cover. When the top cover is opened and rotated to the back of the bottom cover, the first magnetic elements and the second magnetic elements attract each other so as to prevent the first folding part or fourth folding part from slipping relative to the bottom cover.

In a preferable embodiment, the first magnetic element is magnet; and the second magnetic element is also magnet.

In a preferable embodiment, the first folding part and the fourth folding part form a symmetry with each other.

According to the above solution, the protective case can provide a reversible support for the tablet computer in vertical direction.

In conclusion, the present invention has following beneficial effects: it has simple structure and it can provide support for tablet computer in vertical direction, thus it is easy to use for user.

Other aspects, features, and advantages of this invention will become apparent from the following detailed description when taken in conjunction with the accompanying drawings, which are a part of this disclosure and which illustrate, by way of example, principles of the present invention.

### BRIEF DESCRIPTION OF THE DRAWINGS

FIG. 1 is a schematic diagram of a protective case for tablet computer of the present invention;

FIG. 2 is a perspective view of a base body of the protective case of the present invention;

FIG. 3 is a schematic diagram of a cover body of the protective case of the present invention; and

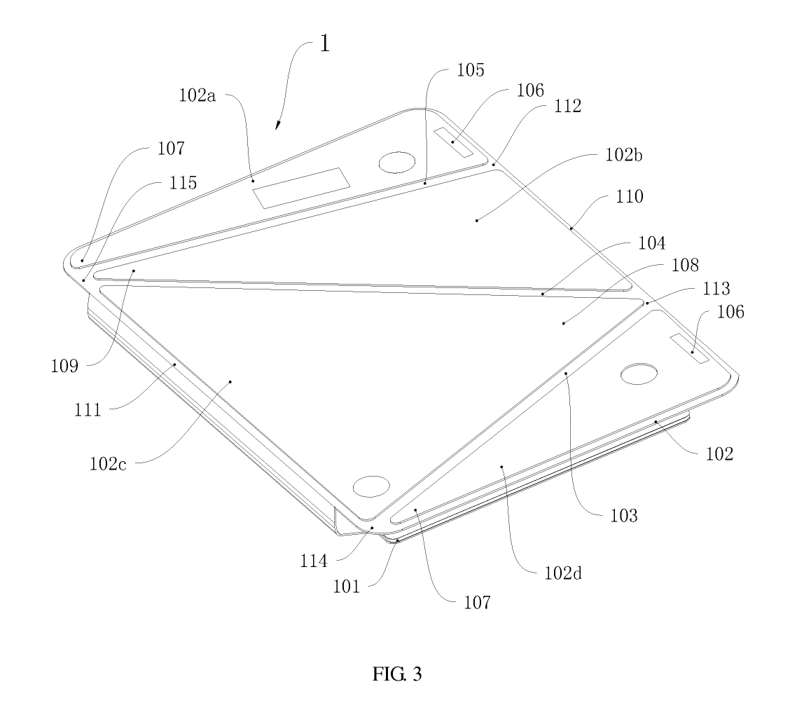

FIG. 4 is a schematic diagram showing a tablet computer supported by the protective case of the present invention.

### DETAILED DESCRIPTION OF ILLUSTRATED EMBODIMENTS

Some embodiments of the present invention will be described as follows, by way of example only, with reference to the accompanying drawings. And it should be noted that the features of different embodiments could be combined if there is no conflicts.

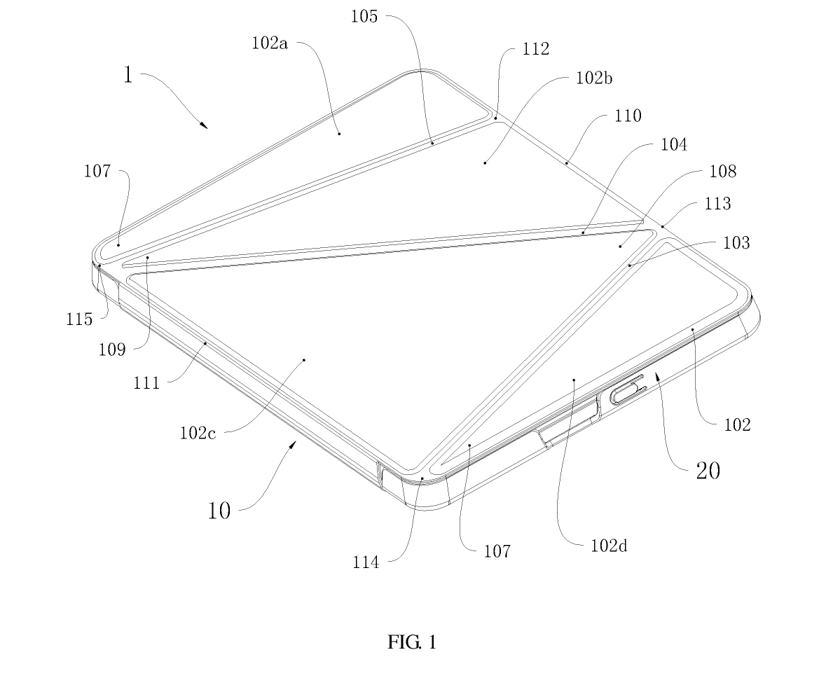

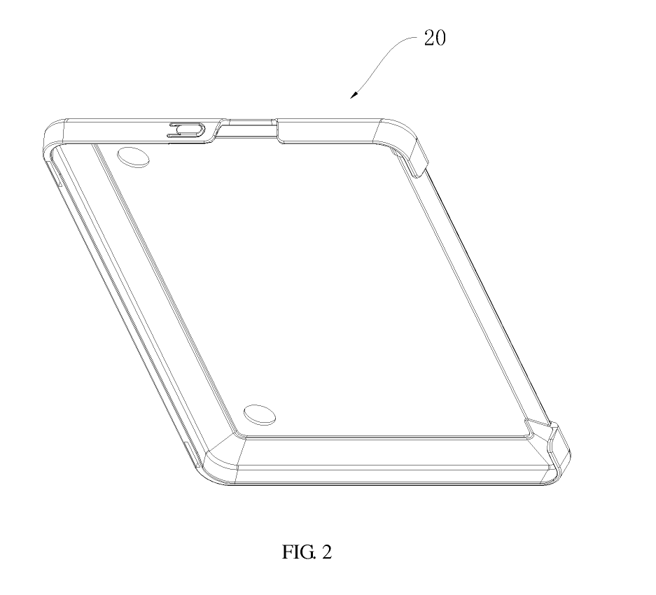

As shown in FIG. 1 and FIG. 2, the protective case for tablet computer 1 includes a base body 20 for holding a tablet computer. The protective case for tablet computer 1 further includes a cover body 10 covering on the base body 20. The cover body 10 includes a bottom cover 101 tightly attached to the base body 20 and a top cover 102 connected with the bottom cover 101 and forming a detachable structure together with the top cover 102. The top cover 102 is divided into a first folding part 102a, a second folding part 102b, a third folding part 102c and a fourth folding part 102d by a first crease 105, a second crease 104 and a third crease formed on a top surface of the top cover 102. The first crease 105 extends from a first point 112 on a free edge 110 of the top cover 102 to a rotating edge of the top cover 102 and the second crease 104 extends from a second point 113 on the free edge 110 of the top cover 102 to the rotating edge 111 of the top cover 102. The first crease 105 and the second crease 104 are converged at a corner 115 close to the rotating edge 111 of the top cover 102, and the third crease extends from a second point 113 on the free edge 110 of the top cover 102 to another corner 114 close to the rotating edge 111 of the top cover 102.

When the tablet computer is not in use, the cover body 10 is covered on the base body 20. When the tablet computer is in use, the bottom cover 101 is supported by the first folding part 102a or the fourth folding part 102d and the first folding part 102a or the fourth folding part 102d contacts with an external supporting surface, thereby the tablet computer is supported by the cover body 10 in vertical direction so as to satisfy the needs of the user.

The protective case for tablet computer according to claim 1, wherein the first folding part 102a has a first corner 107 with a range of 15-25 degree and the first corner 107 is opposite to the free edge 110. The second folding part 102b has a second corner 109 with a range of 20-30 degree and the second corner 109 is opposite to the free edge. The third folding part 102c has a third corner 108 with a range of 55-65 degree and the third corner 108 is opposite to the rotating edge 111. The fourth folding part 102d has a fourth corner 107 with a range of 15-25 degree and the fourth corner 107 is opposite to the free edge 110. In this specified embodiment, the first corner 107 is 20 degree; the second corner 109 is 25 degree; the third corner 108 is 60 degree; and the fourth corner 107 is 20 degree. The first folding part 102a, the second folding part 102b, the third folding part 102c and the fourth folding part 102d are all triangular structures.

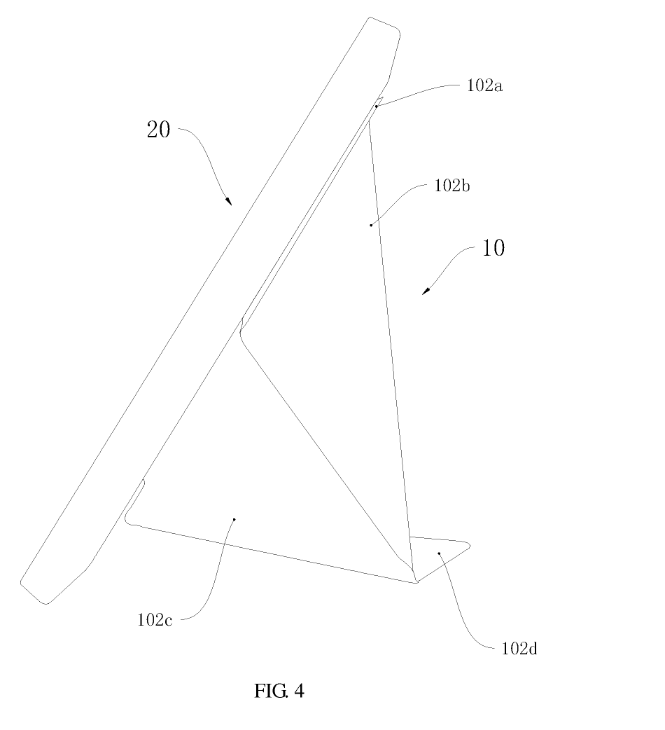

Both of the first folding part 102a and the fourth folding part 102d are provided with a first magnetic element 106 at a position close to the free edge 110; and the bottom cover 101 is provided with second magnetic elements corresponding to the first magnetic elements 106. The first magnetic element 106 is magnet; and the second magnetic element is also magnet. As shown in FIG. 1 and FIG. 4, when the top cover 102 is covered on the bottom cover 101, the first magnetic elements 106 and the second magnetic elements 106 attract each other so as to prevent the top cover 102 from moving relative to the bottom cover 101. When the top cover 102 is opened and rotated to the back of the bottom cover 101, the first magnetic elements 106 and the second magnetic elements 106 attract each other so as to prevent the first folding part 102a or fourth folding part 102a from slipping relative to the bottom cover 101.

Above descriptions of embodiments are provided for further illustrating the technical content of the present invention, so as to facilitate understanding. It should be understood that the invention is not to be limited to the disclosed embodiments. Any technique extension and recreation according to the present invention should be included within the scope of protection of the invention.

What is claimed is:

1. A protective case for tablet computer, comprising a base body for holding a tablet computer, wherein the protective case for tablet computer further comprises a cover body covering on the base body, the cover body comprising a bottom cover tightly attached to the base body and a top cover connected with the bottom cover and forming a detachable structure together with the top cover; the top cover is divided into a first folding part, a second folding part, a third folding part and a fourth folding part by a first crease, a second crease and a third crease formed on a top surface of the top cover; the first crease extends from a first point on a free edge of the top cover to a rotating edge of the top cover, the second crease extends from a second point on the free edge of the top cover to the rotating edge of the top cover, the first crease and the second crease are converged at a corner close to the rotating edge of the top cover, and the third crease extends from a second point on the free edge of the top cover to another corner close to the rotating edge of the top cover; and
when the top cover is opened and rotated to the back of the bottom cover, the bottom cover is supported by the first folding part or the fourth folding part and the first folding part or the fourth folding part contacts with an external supporting surface.

2. The protective case for tablet computer according to claim 1, wherein the first folding part has a first corner with a range of 15-25 degree and opposite to the free edge.

3. The protective case for tablet computer according to claim 2, wherein the second folding part has a second corner with a range of 20-30 degree and opposite to the free edge.

4. The protective case for tablet computer according to claim 3, wherein the third folding part has a third corner with a range of 55-65 degree and opposite to the rotating edge.

5. The protective case for tablet computer according to claim 4, wherein the fourth folding part has a fourth corner with a range of 15-25 degree and opposite to the free edge.

6. The protective case for tablet computer according to claim 5, wherein the first corner is 20 degree; the second corner is 25 degree; the third corner is 60 degree; and the fourth corner is 20 degree.

7. The protective case for tablet computer according to claim 1, wherein both of the first folding part and the fourth folding part are provided with a first magnetic element at a position close to the free edge; and the bottom cover is provided with second magnetic elements corresponding to the first magnetic elements.

8. The protective case for tablet computer according to claim 7, wherein the first magnetic element is magnet; and the second magnetic element is also magnet.

9. The protective case for tablet computer according to claim 1, wherein the first folding part and the fourth folding part form a symmetry with each other.
